(19) United States
(12) Patent Application Publication
(10) Pub. No.: US 2009/0327423 A1
(43) Pub. Date: Dec. 31, 2009

(54) COMMUNICATION METHOD AND COMMUNICATION SYSTEM

(76) Inventors: Alexander Puschkin, Berlin (DE); Caveh Valipour Zonooz, Berlin (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/122,420

(22) Filed: May 16, 2008

Related U.S. Application Data
(60) Provisional application No. 60/938,725, filed on May 18, 2007.

(51) Int. Cl. G06F 15/16

(52) U.S. Cl. 709/205

(57) ABSTRACT

Communications method, comprising the steps: entering a posting to an addressee into a communications platform, publishing the posting on the communications platform, reviewing of the posting by users of the communications platform, selection of at least one posting based on the reviews, transmitting the posting to the addressee, and publishing the answer from the recipient on the communications platform.

### FIELD OF THE INVENTION

The present invention relates to communication methods and communication systems, in particular, communication methods and communication systems utilizing the internet.

### BACKGROUND OF THE INVENTION

If one considers for example the digital diary of an organisation (weblog), then the company has a marketing instrument to hand, with the aid of which information and concerns can be brought very easily to a wide public. This information is up to date, relevant and prepared in a multimedia format—often even as a video or audio document. The first weblogs were written by internet enthusiasts, who periodically published current events and information from their private lives on simple web pages. From 2004 weblogs, also known as blogs for short, have also increasingly been used by online media, traditional media and other service providers to extend their readership and relationship to their customers.

This conventional communication method opens up the opportunity for an individual or an institution to present up to date and especially multi-media content to a relevant user group at low cost. This represents the standard one-to-many (or also top-down) communication process.

### SUMMARY

In view of the above, a communication method includes entering a posting to an addressee into a communications platform, publishing the posting on the communications platform, reviewing of the posting by users of the communications platform, selection of at least one posting based on the reviews, transmitting the posting to the addressee, and publishing the answer from the recipient on the communications platform.

Furthermore, a communication system is provided which includes an input means for entering a posting to an addressee into a communications platform, a publishing means for publishing the posting on the communications platform and for publishing an answer from the recipient on the communications platform, a rating means for rating of the posting, a selection means for selecting of at least one posting based on the user ratings, and a transmission means for transmitting the selected posting to the addressee.

Further aspects, details, advantages and features follow from the dependent claims, the description and the attached drawings. Embodiments are also directed at apparatuses for carrying out the disclosed methods and including apparatus parts for performing each described method step. These method steps may be performed by way of hardware components, a computer programmed by appropriate software, by any combination of the two or in any other manner. Furthermore, embodiments according to the invention are also directed at methods by which the described apparatus operates. It includes method steps for carrying out every function of the apparatus.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, wherein:

FIG. 1 is a schematic representation diagram of a communication method according to an exemplary embodiment.

FIG. 2 shows a flow diagram of a communication method and system according to an embodiment.

FIG. 3 shows a flow diagram of a communication method and system according to another exemplary embodiment.

FIG. 4 shows a flow diagram of a communication method and system according to still another exemplary embodiment.

FIG. 5 shows a flow diagram of a communication method and system according to a further exemplary embodiment.

FIG. 6 shows a schematic comparison of different communication methods.

FIG. 7 shows a schematic drawing of a communication system according to an exemplary embodiment.

FIG. 8 shows a schematic drawing of a communication system according to a further embodiment.

### DETAILED DESCRIPTION

Reference will now be made in detail to the various embodiments of the invention, one or more examples of which are illustrated in the figures. Within the following description of the drawings, the same reference numbers refer to same components. Generally, only the differences with respect to individual embodiments are described. Each example is provided by way of explanation of the invention and is not meant as a limitation of the invention. For example, features illustrated or described as part of one embodiment can be used on or in conjunction with other embodiments to yield yet a further embodiment. It is intended that the present invention includes such modifications and variations.

In the following the term “communication” refers to the transmission of information between persons, in particular the transmission of information from a single person to many other persons (so-called one-to-many communication), many persons to a single person (so-called many-to-one communication) and between many users (so-called many-to-many communication).

Communication of this type is normally based on more or less (depending on number of participants) hierarchically structured communication stages, and especially on paths that are remote from the public.

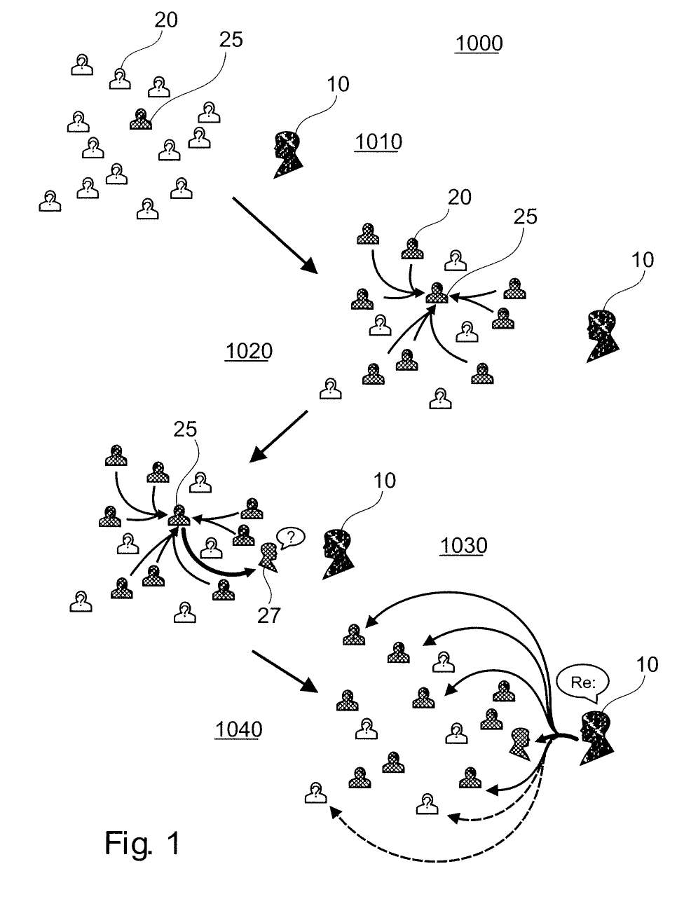

FIG. 1 is a schematic representation diagram of a communication method 1000 according to an exemplary embodiment. Therein, a single recipient 10, e.g. a well-known politician, actor, musician, company, institution, or organization faces many supporters, fans, or users who would like to directly communicate with the recipient. Due to the number of supporters, fans, or users 20, the recipient 10 will not be able to answer all the letters, emails and other communications sent to him when using normal communication channels. According to the embodiment, a user 25 may post a message to the recipient 10 on a public communications platform (step 1010). In some embodiments, the user 25 may send an email with the text or documents to be posted to a defined email address and will receive a verification link. By clicking on this verification link, the user 25 can publish his message on the platform. In other embodiments, audio and/or video files may be uploaded as postings. In one embodiment, the posting may include the entry of a new communication thread, by means of which a dialog is potentially initiated. In some embodiments, the posting undergoes a relevance test in which unsuitable postings are labelled manually by moderators or other users, in order to be automatically or manually removed instantaneously or later in the process. Alternatively or additionally, the method may include automatic recognition of previously existing or already answered questions. Typically, a similarity criterion is used to identify postings related to already answered questions and/or already existing postings. For example, a keyword-based search algorithm may be applied to identify postings of similar content. By filtering such redundant postings, the efficiency of the communication method may be enhanced. Alternatively or additionally, the method may further include automatic blocking of unsuitable content, e.g. offensive or insulting content. In a further embodiment, postings are automatically and/or semi-automatically translated into one or more other languages so that the number of users addressable by the posting is enlarged.

Thereafter, the posting is published on the communications platform so that the other users 20 have access to the posting. After being published, the other users have the opportunity to review the posting and to rate it (step 1020). In one example, a user may assign between 0 and n points to the posting, wherein 0 points means that the posting is irrelevant to the user and n points means that the user fully supports the opinion or question contained in the posting. In other embodiments, the users may adjust a slider to rate the posting. In particular, any method of quantifying the users personal feeling about the posting may be implemented and used in the present method to rate the posting. In some embodiments, a user may choose between different rating methods. Furthermore, users may also enter comments to the posting. For example, such comments may be entered as text, audio, and/or video files.

According to further embodiments, text-based metadata may be inserted into multimedia postings. Additionally or alternatively, definitions for selected terms within a posting may be displayed. For example, the definition of the term may be displayed on mouse-over. In one embodiment, terms for which definitions can be displayed are highlighted. In another example, the definition of the term is a maximum of 300 characters long so that it can be displayed in a small window on a computer screen. According to an even further embodiment, information related to the content of a posting may be displayed together with the posting. Such related information may include e.g. background reports or current information. All the aforementioned additional information, metadata, definitions or the like may be added by editors of the communication portal and/or by users and/or automatically. Furthermore, comments or additional information added by users may be reviewed by editors and/or users to filter offensive of non-suitable content.

Alternatively or additionally, advertisement may be displayed together with a posting. In some embodiments, the advertisement is related to the content of the posting. For example, a posting related to environmental issues may be accompanied with advertisements of sustainable investments or energy-saving products.

Next, a posting is selected based on the reviews and/or the ratings of the users 20. In one embodiment, a certain number of postings (e.g. three) having the highest rating at the end of a certain period (e.g. one week) are selected at the top postings of this week. In a further embodiment, the top postings from a predefined period of time are automatically summarized. The selected posting and/or selected postings are transmitted to the recipient or addressee 10 (step 1030). Thus, the posting 27 by user 25 is selected via the above-described public review process and presented to recipient 10. Recipient 10 can be sure that the selected posting addresses an issue supported by a majority of the users 20. Accordingly, an answer provided by recipient 10 will be not only of interest to user 25 but also to the majority of other users 20. Therefore, recipient's answer to the selected posting will be published on the communications platform (step 1040). In some embodiments, the answer will only be available for a user on payment of an access fee. In another embodiment, the answers by recipient 10 may be commented by users 20, and a dialogue between recipient 10 and users 20 may be initiated. In another embodiment, questions/postings and answers may be automatically merged. Thus, self-contained information relating to a specific issue may be formed.

In the following, an example for the above-described communications method is described. In this example, the German Chancellor speaks to the German nation in a weekly video address over the internet. She thereby takes advantage of the above mentioned advantages of the internet and weblogs.

A very successful application of the concept described herein (many-to-one communication) can be found at the communications platform www.direktzurkanzlerin.de, which is a communications portal built by the present inventors. By means of this communications platform, people can communicate directly with the German Chancellor Angela Merkel (many2one communication). Since it is of course not possible for every single concern to be brought to the Chancellor, the above-described communication method was implemented. Thus, a person's concern is transparently reviewed, rated and finally reaches the Chancellor with appropriate relevance. Here, citizens have the chance to respond to the Chancellor's addresses and to raise their own concerns and questions. The platform www.direktzurkanzlerin.de therefore serves as a public medium and offers the unique possibility of sending one's own “letter” in the form of a text, audio or video document to the German Chancellor. The difference and also the advantage over the conventional method of “letter posting” via email, fax or post is inter alia the presentation of the concern in a way that is effective for the audience. In the communication method described herein, other citizens have the opportunity to follow this contribution and to lend it more force and emphasis merely by the statement “This contribution has relevance for me and I support it.” (made through an active review process or other statistical methods). As a result of these reviews, a filtered selection of views reaches the German Chancellor, or her representative offices. The filtering of the concerns therefore occurs directly due to the citizens (users), that is, the users of the platform. They themselves determined the relevance and quality of a contribution and select it.

The advantage of this restriction to a small number of top contributions rests in the fact that the German Chancellor, or other responsible persons, only have to deal with small numbers of contributions and can respond to them with appropriate thoroughness. These few contributions, limited by the public filtering process, represent a reflection of public opinion on concrete issues and their relevance. This is information of great value for officials of the German Chancellor's Office that was previously unable to be efficiently acquired with standard methods. That is one of the reasons why the German Chancellor's Office has declared itself to be prepared to respond to 3 of the best contributions every week.

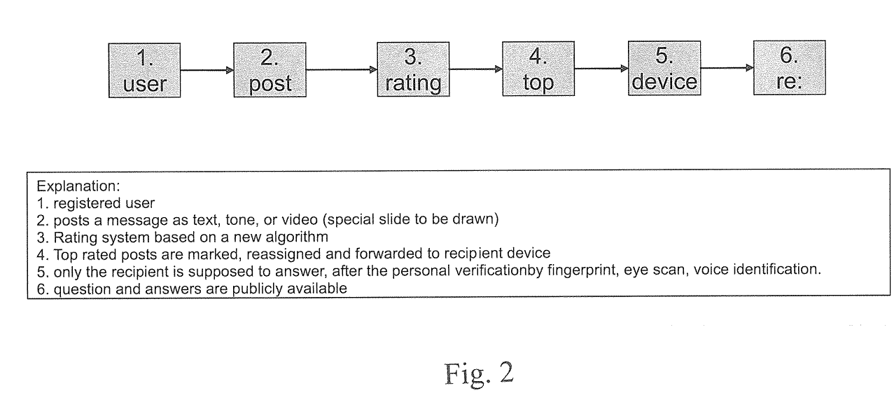

These properties of the communication method are reproduced by way of example in FIGS. 2 to 6, which each illustrate various exemplary embodiments or aspects of the communication method. The details of the illustrated exemplary embodiments are also shown by the text included in the Figures.

FIG. 2 shows a flow diagram of a communication method according to an embodiment. Therein, a user registers to have access to the communications platform. In a next step, the registered user posts a message to the recipient, e.g. a politician, on the communications platform. The message may be posted as a text message, audio or video message. Subsequently, the posting undergoes a review process in which the other users of the portal review the posting and rate its relevance. At step 4, the top rated postings are selected and forwarded to the recipient. In order to guarantee that the answers to the selected postings are provided by the recipient, the selected postings may only be transmitted to a predefined device which is only accessible by the recipient and/or a person assigned by the recipient. For example, such a device may be a specific computer, personal digital assistant (PDA) or the like. Furthermore, the specific device may include means for identifying the recipient, e.g. fingerprint identification, eye scan, and/or voice verification. Thus, it can be guaranteed that the selected postings will be answered by the recipient or a person entrusted by the recipient. In a final step 6, recipient's answer will be published and made publicly available at least to the users of the portal. Of course, also recipient's answer may be in the form of a text message, an audio and/or a video file.

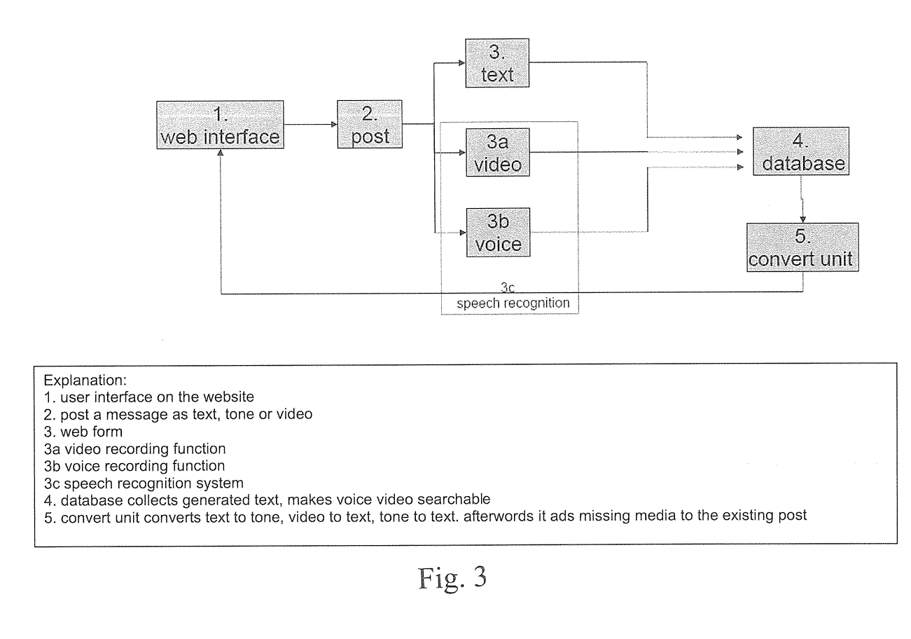

FIG. 3 shows a flow diagram of a communication method according to another exemplary embodiment. Therein, a user interface is provided on an internet website. The web interface allows the user to post a message as text, audio and/or video message. To this end, a web form 3 is provided by the web interface for recording text messages. In addition, a video recording function 3a is provided by the web interface so that a user may record a video message, e.g. via a webcam. Furthermore, an audio recording function 3b is provided by the web interface so that a user may record an audio message, e.g. via a built-in microphone. Furthermore, a speech recognition system is provided. The speech recognition system analyzes video and/or audio messages posted via the web interface. Thus, the spoken words are transformed into text which is saved in a database 4. Thus, audio and/or video postings are made searchable by a text-based search algorithm. In one embodiment, the system further includes a convert unit 5 which is adapted to convert text into sound so that the postings/answers are easier accessible to visually handicapped persons. Likewise, the text generated by the speech recognition system is made available to provide access for hearing-impaired persons. The original postings will be automatically supplemented with this additionally generated information.

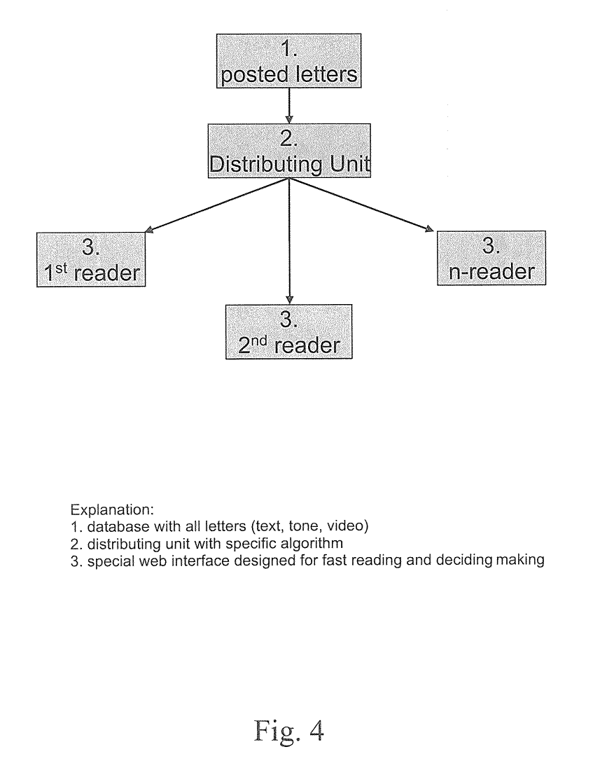

FIG. 4 shows a flow diagram of a communication method and system according to still another exemplary embodiment. Therein, a database 1 holds the postings which may be provided as text, audio and/or video messages. A distribution unit 2 is adapted to distribute the postings according to a specific algorithm to identified recipients. The recipients have a specifically designed web interface 3 which allows fast access and reading of the postings. In one example, the system is implemented in a company and the identified users are managers of different business areas. In this example, the specific algorithm filters the postings so that only postings concerning the specific business area are communicated to the manager of this business area. Thus, the most important concerns of a particular business area are effectively communicated to the manager.

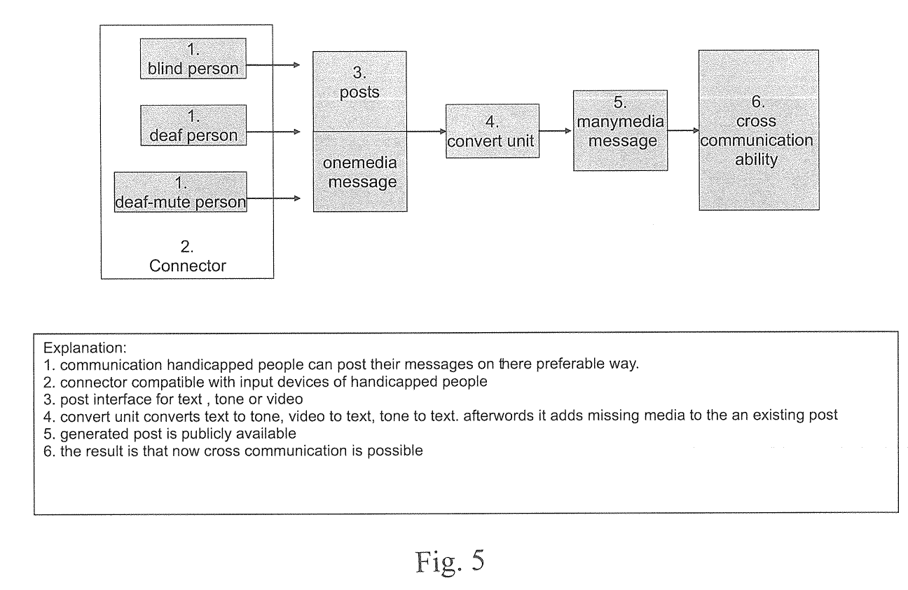

FIG. 5 shows a flow diagram of a communication method and system according to a further exemplary embodiment. The communication method and system shown in FIG. 5 is specifically adapted to include handicapped persons in the public communication process. To this end, the system provides a connector 2, which may be realized as a specific web interface. Connector 2 is compatible with the specific input devices for handicapped persons as they are known in the art. Thus, connector 2 allows a handicapped person to enter a posting in a preferred way, i.e. as a text message, an audio message and/or a video message. Furthermore, the system includes a conversion unit 4 adapted to convert the posted message in another media. For example, conversion unit 4 may convert text into sound, or audio and/or video messages into text as has been described above. The different forms of the post will be published on the communications platform 5 and undergoes the above-described public review and rating process. Since also comments and answers to the posting can be made in any form (text, audio, video) and will be converted by conversion unit 4, cross communication via different media is enabled by the described system and method. In particular, handicapped persons can be effectively involved in public discourse.

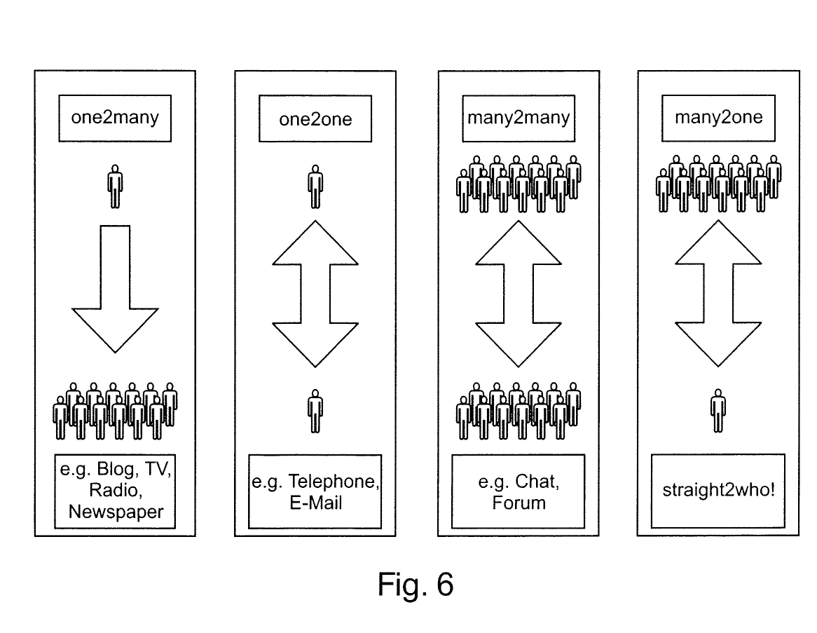

FIG. 6 shows a schematic comparison of different communication methods. A first known method involves so-called one-to-many communication in which a single author addresses a large public. Typical examples of one-to-many communication are TV, Radio, Newspapers, Blogs or the like. A second method involves so-called one-to-one communication in which two persons communicate with each other. Typical examples of one-to-one communication are telephone conversation, letters, or the like. A third method involves so-called many-to-many communication in which a first group of persons communicates with at least a second group of persons. Typical examples of many-to-many communication include internet chat rooms or forums. Finally, the communication method described herein involves so-called many-to-one communication in which a large group communicates with a single person, company or institution via a public review and rating process. The independent users ensure the relevance of the submitted contributions. Contributions violating laws or other regulations can be reported by the users and/or editors and removed by moderators.

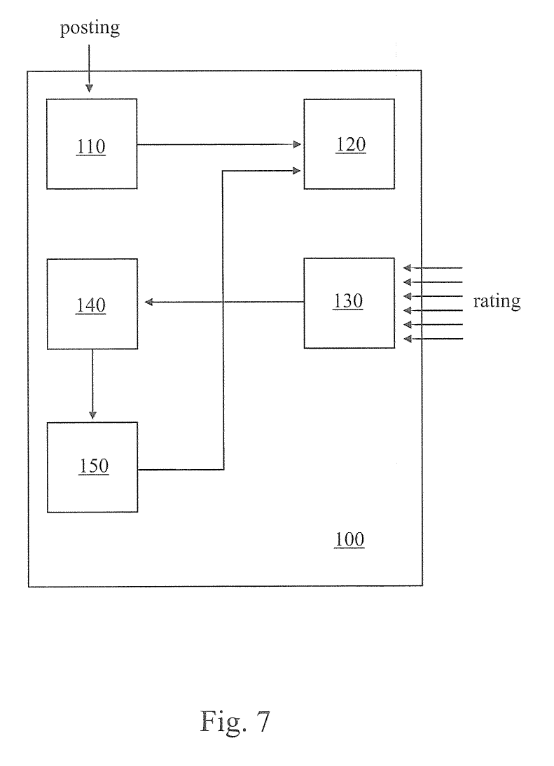

FIG. 7 shows a schematic drawing of a communication system according to an exemplary embodiment. Therein, a communication system 100 includes an input means 110 adapter for entering a posting to an addressee into a communications platform. Communication system 100 further includes a publishing means 120 adapted for publishing the posting on the communications platform. The communication system 100 also includes a rating means 130 via which users of communication system 100 can rate postings. Furthermore, a selection means 140 is provided in communication system 100. Selection means 140 is adapted to select at least one posting based on the user ratings. Typically, one or more postings having the highest rating are selected by selection unit 140. Selection unit 140 may perform a statistical algorithm to determine the postings to be selected. Finally, communication system 100 includes a transmission means 150 for transmitting the selected posting(s) to the addressee. An answer of the addressee to the selected postings can be published on publishing means 120 and, thus, made publicly available.

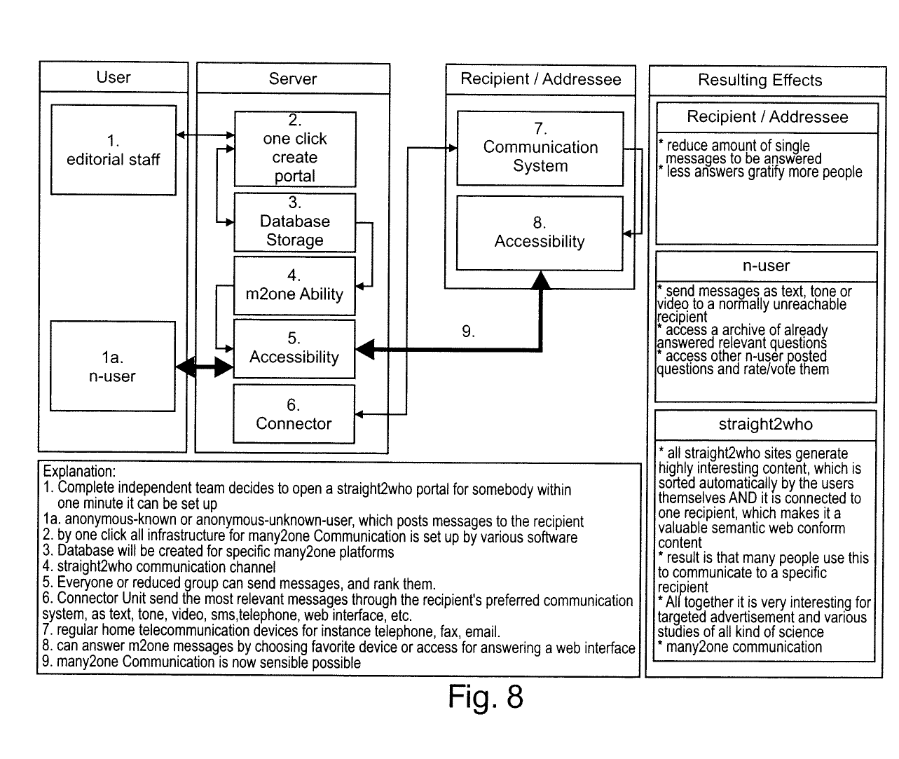

FIG. 8 shows a schematic drawing of a communication system according to a further embodiment. Therein, an editorial staff 1 provides a communication portal for many-to-one communication. Furthermore, a potentially unlimited number of users 1a may access the portal via the internet. The communication portal is implemented on a server. In one embodiment, the implementation is accomplished by a one-click infrastructure allowing easy and quick setup of a communication portal. Typically, a database 3 is created and provided on the server. Alternatively, an interface to an already existing database is created so that the newly created portal can access and use the existing database. Database 3 serves for storing postings, answers, metadata, and other information related to the portal. The portal includes a many-to-one communication channel 4 which allows for the above-described functions of many-to-one communication. This communication channel 4 can be accessed by the users 1a and by the editorial staff 1. The users may post messages, comments and/or rate postings of other users. A selection and transmission unit 6 selects the highest rated postings and sends them to the communication system of the recipient. The recipient answers the selected postings by any of a text, audio or video message and sends the answer back to the server so that the answer can be published.

In the following, various applications of the above-described methods and systems will be described. Those applications shall be understood as non-limiting examples of possible implementations of embodiments of the present invention.

### Application in the Corporate Sphere

The communication method and communication system can also be used in the corporate sphere. The application to corporate communication promises immense potential. In many companies there are numerous opportunities for employees to raise their concerns, suggestions and criticisms at the management level. These include e-mail, intranet forums etc., but also traditional means such as “suggestion boxes” or similar. Here, the communication method creates a public status for an issue that is usually lacking, and a possibility of support by other employees, which up to now has not been possible in such a simple manner. The advantages include the fact that the management level (and also the employees) can use this instrument to refer back to current and particularly relevant information from the entire company, and at the same time has the opportunity to see which topics worry their employees the most. A further area of application for the concept is the full utilisation of the available human resources in companies. Every employee has ideas and suggestions, with which he or she can improve their personal working routine and that of others. Current methods do certainly motivate employees to communicate their ideas, but they are only used by few, since the ideas usually are not fully fleshed out or, in the opinion of the person suggesting them, not worthy of communicating. For many companies lacking an innovation culture, it is precisely because of the inadequate communications structures that they cannot overcome the competition and stand out from the rest. The innovation usually already exists, but is not transmitted right to the top by the originator of the idea (e.g. a trainee), since the necessary mechanism is lacking for passing upwards ideas generated in particular by those employees at the bottom levels of the hierarchy. Using many-to-one communication however, even the very smallest idea can be readily published. Using the method of public review, every suggestion is appraised by other employees—everyone therefore being on an equal footing. If many employees approve of a suggestion, the probability that the management attends to it increases. The advantage of this is apparent. The management does not have to process and review a multitude of suggestions. Rather, a selection of employees exists—i.e. of those who in most cases would have been positively or negatively affected by the implementation of the suggestions. These are data which otherwise would only have been brought to light using complicated additional methods.

As well as internal corporate communication, it is also possible to adopt such a medium as a channelling process for external communication, e.g. with the shareholders and customers. Detailed ideas for product improvement and support queries are weighted by the reviews according to their relevance; the important customers are given assistance earlier.

The public review enables chains of creativity, an initial idea leading to the next one and so on. The company then only needs to implement the results of these discussions with the expertise already available. The results are fast product cycles, rapid error elimination, greater customer satisfaction, even if the error is not removed, because the customer is being given attention. Furthermore, companies can respond more quickly to customer demands, because these are explicitly expressed. Costly studies can thus at least partially be dispensed with.

Scope of Application: Corporations and their CEOs

A very large organisation is usually characterised by numerous specialist departments. It is important for the CEO to know what happens in these specialist departments. This is nowadays normally done by numerous meetings, in which the heads of the specialist departments inform the CEO of their current position and results. Usually these meetings are highly inefficient.

Each specialist department and/or every level of the hierarchy can access the contributions of equal-status employees and those of the levels underneath. This is important, since there is information which is not relevant to the lower levels. The advantage in this situation is with the CEO. This person obtains an overview of the questions from all employees and the answers from their heads of department. In other words it is a case of a Quality Management system and more effective control in the hands of the management layer, or the CEO respectively.

### Application in Other Areas

The use of the communication method is also conceivable in other spheres of life, for example, but not limited to: people in the media like stars and celebrities; at special events: astronauts, football teams, top sportspeople; faces in the news, e.g. people who become known to a wide public overnight via the press or similar media; strikes, trade unions; political demonstrations; specific events, e.g. World Cups, Olympic Games; filmmakers, film studios, publishers, and authors.

For only a small cost a portal can be created for a “recipient”, which immediately generates income both directly and indirectly. From the recipient's point of view, communications costs in terms of answering general mail, fan mail, ideas, suggestions etc. are rationalized enormously. This principle produces great benefits for the prospective client, since it creates the possibility via an independent platform for meaningful contact with a recipient. An advantage of this principle is the fact that a win-win situation between sender and recipient results. An interested person or institution however has the opportunity to set up such a platform themselves.

The communication method behind many-to-one communication is divided into multiple process stages, which can be embodied either individually or in arbitrary combinations as a communication method: entry of a new communication thread (contribution), by means of which a dialogue is potentially initiated. Furthermore, an edited review process may be implemented and may allow reviewing the contributions with regard to multiple aspects, including but not being limited to: Relevance—inappropriate (so-called off topic OT) contributions can be manually flagged by moderators or other users, in order to be automatically removed later in the process; Duplicates—already existing, or even already answered questions can be detected on the basis of similarity and be eliminated even while still being written; Blocking of unsuitable content. Furthermore, postings and/or other contributions may be commented, thus initiating a dialogue. This option can be made available to all users and/or exclusively to the author of the query. Alternatively or additionally, top contributions for a specified period of time (e.g. day, week, month) may be summarized to give a brief overview.

The communication method may comprise the following steps: A question can be asked by a person in the form of text, audio or video. The question is published in the platform www.direktzurkanzlerin.de and/or www.straight2who.com. Every member of the community now has the opportunity to review every single question. From the reviews by the community members, every question is ordered by importance. The three most important questions are forwarded each week to the recipient (e.g. the German Chancellor) for answering. The recipient (e.g. the Press Office) usually answers the three most important questions within 72 hours. The answers are again published in the community. Questions and answers remain open for further discussion.

Advantages and limitations of the above-described communication methods and systems with respect to already existing media and IT solutions, such as websites, forums and blogs include among other things: Channelling: the communication is channelled to one or a small number of contacts; Directed communication: the communication is directed to a recipient; Review process: the reviewing system has a controlling function and is therefore also more likely to be used than purely informative/optional reviews; Categorisation: postings may be categorized with respect to subjects, date, authors, contacts or any other suitable category; Interactivity: feedback is possible at any time; Community: the totality of the contributors forms a community; group formation within the community implies a common interest; Guarantee for answers: once the system is established, answers are bound to arrive, ideally regularly or even in real time; Multimedia: communication can take place by video, audio or text and can be made 100% barrier-free. In some embodiments, the postings and/or the answers and/or the rating functionality may be provided in a from that allows a user and/or recipient to embed the posting and/or answers and/or rating functionality in another website.

In one embodiment, the communication platform enables podcast functionality. By the use of podcast technology it is possible, via new video contributions to regularly stay up to date, without having to specially visit the site directly. The threshold for participation is therefore lowered.

Furthermore, users can upload their contributions as sound/video posts or enter them directly on the platform (without additional installation directly in the web browser). Text posts are converted to audio automatically and/or manually. This allows their contents also to be downloaded as podcasts. Users can thus also consume content when they are not surfing online on the portal web pages. Text postings and text answers are converted to audio by a software application and provided as a podcast. Beforehand, “the question” is spliced together with “the answer”.

In another embodiment, sound and video files are scanned using specific software. From this, text-based metadata is added to the multimedia files, so that the search functions also display multimedia posts. This makes the portal accessible also to people who are physically handicapped, or unable to write. Videos and sound files are analyzed by innovative speech recognition software. Through cooperation with organisations for disabled people, communications devices of these associations are supported by the system. This enables totally barrier-free communication. In one example, live recordings are enabled directly on the website. Video and audio messages can be conveniently listed and posted on the portal. Discussions between users are also conducted with sound, text or video messages. With every contribution, advertising relevant to the content can be displayed. With every contribution, information relevant to the content can be displayed. The latest developments in the subject, from news, blogs, or web pages can be displayed. Background reports for a better understanding of the questions and arguments can be provided. Videos and audio postings, from TV and other media can be provided. Wikipedia articles, biographies of people mentioned, links to the wording of laws etc. can be provided. According to embodiments, one or more of the aforementioned functions may be automatically performed by the communication system.

In one embodiment, individual words are automatically discreetly tagged in a posting, so that when the mouse is later placed over them, an explanation of the term appears in a small window. This relies on a powerful data base of explanations, which are each a maximum of 300 characters long. When the term is clicked on, however, a complete explanation can be read from wikipedia, or better, from a database created by the users themselves. This database can be different from portal to portal, depending on the recipient being addressed.

In another embodiment, an automatic translation method is implemented so that all or only selected contributions are translated into other national languages automatically and/or semi-automatically. In this way one can facilitate simple communication across national borders.

According to still another embodiment, video or audio contributions can contain activatable subtitles. In some embodiments, different languages can be selected for the subtitles.

In one embodiment, the system checks all other existing postings at the time a user starts to write a posting. If there are one or more hits based on correspondence in content, the authors are discreetly informed of this. They are then given the simple option of communicating with each other about the topic, and therefore of strengthening the weight and the argumentation of a posting. In other words, they are linked together, namely using a special piece of software. While the posting is being entered, the system uses the database and an algorithm to check whether there is already an answer to this posting. If yes, a few answers are typically suggested underneath the posting.

In further embodiments, the communication portal includes software interfaces to Blackberry, Ipod, Symbian, Windows Mobile, Palm, Mobile Linux, etc.

According to a further aspect, well-known/important recipients may be equipped with a specific communications device displaying the most relevant contributions as text, audio or video. Access to this is only possible with a fingerprint/iris scan, which guarantees that the postings can and will only be answered by the correct recipient. In this way, confidence among the users can be increased. The communications device may be set up, operated and monitored by an operator, and may remain in the property of the operator. In one embodiment, a display, webcam, keyboard, microprocessor, etc. are integrated in the device. Furthermore, the device may be adapted to retrieve its data via an ultra-high security encrypted link directly from the operator.

According to a further embodiment, using a small piece of low functionality software or a website for mobile telephones, PDAs, laptops etc., postings can be displayed quite easily, and can then be approved or negated. With at least a number x of No's (e.g. 10), a posting is put into a “Deletion candidate area”. With at least a number x of Yes's (e.g. 10), the posting again becomes visible online. This option can then be offered to the interested parties, educational institutions, non-profit organisations and similar socially useful institutions. Such a process may be applied in the method and system shown in FIG. 4.

By linking of content, a new high-quality novel reference work for all areas of life can be developed. Unlike in Wikipedia, the relevance of information is given useful expression by the communication method on the portal. A topic barometer of the actual level of interest from the population, the employees, or the clients can be created. The communication method can also be used e.g. to analyse throughput rates for new products, or political views and opinions. All communications functions of many-to-one communication can be implemented in a 3D-world in a user-friendly manner. That may enable virtual demonstrations with only a single click. Every citizen of a country may participate in receiving a 100% secure access with his or her personal ID card, in order to fulfil their democratic duties. A citizen may be informed about important decisions by mail and using many-to-one communication, within a short time determine whether he or she is for or against it. With one click, supporters of a view can mobilize themselves and generate a publicly visible statement with millions of approvals.

The communication method and system can be used for a new type of democracy and politics, exchange of arguments, fact and topic based, without political bias. Solution-oriented debates can be conducted in virtual groups. For pressure groups and parties via committees to whole parliaments, which for the purpose no longer need to be physically present in the same place, in order to be quorate. In this system a proposal from an individual or a small group follows the normal procedure. From formulating the issue as a text, audio or video posting via the simple entry in the internet platform right up to debates and referenda—everything happens on a simple to use, integrated and multimedia internet platform. This allows for an accelerated and topic-based debate, which moreover can also still be conducted in public. The quality of the content is therefore increased and allows detached compromises instead of emotionally charged debates around substitutes for the problem. Using the optional up-to-date publication of all discussions a constant open review process is facilitated. The advantages of the time-independent and place-independent gathering of information which the internet offers are transferred with the aid of the internet platform on to democratic debates and decisions. Even for democratic decision-making in companies in which decision makers, just as in politics, are often travelling, it is only rarely that all parties involved can physically sit at the same table. A virtual location enables international debates, even over great distances, and saves organisational and travel costs, time, as well as speeding up decisions.

While the foregoing is directed to embodiments of the invention, other and further embodiments of the invention may be devised without departing from the basic scope thereof, and the scope thereof is determined by the claims that follow.

1. A communication method, comprising:
entering a posting to an addressee into a communications platform,
publishing the posting on the communications platform,
reviewing of the posting by users of the communications platform,
selection of at least one posting based on the reviews,
transmitting the posting to the addressee, and
publishing the answer from the recipient on the communications platform.

2. The communication method according to claim 1, further comprising the entry of a new communication thread, by means of which a dialog is potentially initiated.

3. The communication method according to claim 1, further comprising a relevance test, in which unsuitable postings are labelled manually by moderators or other users, in order to be automatically removed later in the process.

4. The communication method according to claim 1, further comprising the automatic recognition of previously existing or already answered questions using a similarity criterion.

5. The communication method according to claim 1, further comprising the automatic blocking of unsuitable content.

6. The communication method according to claim 1, further comprising the automatic summarizing of top postings from a predefined period of time.

7. The communication method according to claim 1, further comprising providing comments to answers, in order to initiate a dialogue.

8. The communication method according to claim 1, further comprising the provision of one or more postings in the form of a podcast.

9. The communication method according to claim 1, further comprising the allowing of uploading of audio and/or video files as postings.

10. The communication method according to claim 1, further comprising the automatic merging of questions and answers.

11. The communication method according to claim 1, further comprising the automatic insertion of text-based metadata into multimedia files.

12. The communication method according to claim 1, further comprising the display of an advertisement which is related to the content of a posting.

13. The communication method according to claim 1, further comprising the display of information related to the content of a posting, e.g. background reports or current information.

14. The communication method according to claim 1, further comprising the display of definitions for selected terms of a posting.

15. The communication method according to claim 14, wherein the definition of the term is displayed on mouse-over.

16. The communication method according to claim 14, wherein the explanation of the term is a maximum of 300 characters long.

17. The communication method according to claim 1, wherein text postings are automatically and/or semi-automatically translated into one or more other languages.

18. A communication system, comprising
an input means for entering a posting to an addressee into a communications platform,
a publishing means for publishing the posting on the communications platform and for publishing an answer from the recipient on the communications platform,
a rating means for rating of the posting,
a selection means for selecting of at least one posting based on the user ratings, and
a transmission means for transmitting the selected posting to the addressee.

19. The communication system according to claim 18, further comprising a web interface for recording a video message and/or an audio message.

20. The communication system according to claim 18, further comprising a speech recognition unit adapted to analyze video and/or audio messages in order to transform spoken words into text.

21. The communication system according to claim 18, further comprising a conversion unit which is adapted to convert text into sound.

22. The communication system according to claim 18, further comprising a predefined recipient device adapted to receive selected postings from the transmission means.

23. The communication system according to claim 22, wherein the recipient device comprises means for identifying the recipient and/or a person assigned by the recipient so that the recipient device is only accessible by the recipient and/or a person assigned by the recipient.

24. A many-to-one communication method, comprising
posting of a text, audio, or video message on a communication portal through a web interface,
editing the posting,
rating of the posting by other users of the communication portal,
selecting at least the highest rated posting,
transmitting the selected posting to a recipient,
preparing an answer to the posting by the recipient,
sending recipient's answer to the communication portal, and
publishing the answer on the communication portal.

25. The many-to-one communication method according to claim 24, further comprising the automatic conversion of sound information into text.
